(19) United States
(12) Patent Application Publication
(10) Pub. No.: US 2003/0087069 A1
(43) Pub. Date: May 8, 2003

(54) Graphic film with improved waveness behavior

(76) Inventors: Robert Winiker, Osnabruck (DE); Roland Bothor, Aachen (DE)

Correspondence Address: Craig J. Arnold, Amster, Rothstein & Ebenstein, 90 Park Avenue, New York, NY, 10016, US

(21) Appl. No.: 10/284,780

(22) Filed: Oct. 30, 2002

(30) Foreign Application Priority Data
Oct. 31, 2001 (DE) 101 53 679.8

(51) Int. Cl. B32B 27/36

(52) U.S. Cl. 428/202; 428/500; 428/480

(57) ABSTRACT

A multi-layer graphic film comprises a printable self-adhesive thermoplastic film and a release liner, whereby the release liner contains a support material that is coated with a polymer film or, at least one side and said polymer film has a ratio of the elasticity modules in longitudinal and transverse direction (MD/TD) of<1, measured according to DIN 53455.

### FIELD OF THE INVENTION

The invention relates to a printable flexible graphic film that can be used for advertising purposes.

### BACKGROUND OF THE INVENTION

A so-called graphic film is generally comprised of a self-adhesive polyvinyl chloride film (vinyl film) and is used to decorate advertising spaces. A support is needed for the production, the transport and the storage of such films. Release liners comprised of a support material and a separating layer are used for this purpose.

For the production of release liners with non-adhesive properties with respect to adhesives, a paper support can be provided with a silicon layer. To keep the expensive silicon layer from penetrating into the paper, the surface of the paper must be sealed. Thus, a suitable support is a paper having either a pigment-containing layer or a polymer coating. Polyolefin is a suitable polymer for this purpose. Using appropriate cooling cylinders in the coating of the raw paper by means of extrusion yields high-gloss surfaces.

A graphic film of this type is printed in large formats, generally in a multi-stage screen-printing process. In that way, the painted or plastic-coated support paper is subjected to high temperatures and various humidity conditions, and disadvantages such as a curling at the edges, or a so-called “twist”-curl or cockling, are observed.

### SUMMARY OF THE INVENTION

The problem underlying the present invention is to provide a graphic film with improved dimensional stability that is distinguished by its improved resistance to the formation of the curling of printable graphic films coated with adhesive, and the form changes in the paper.

This problem is solved by a multi-layer graphic film with a printable self-adhesive thermo-plastic film and a release liner, whereby the release liner comprises a support material that has a polymer film on at least one side, with said polymer film having a ratio of the elasticity module in longitudinal to transverse direction (MD/TD) of<1 according to DIN 53455.

### DETAILED DESCRIPTION OF THE PREFERRED EMBODIMENTS

In a special embodiment of the invention, the ratio MD/TD is in a range of 0.30 to 0.80, especially preferred in a range of 0.4 to 0.7.

The elasticity module of the polymer film in longitudinal direction is preferably 1,600 to 2,500 N/mm² and in transverse direction 3,000 to 4,600 N/mm² according to DIN 53455. The thickness of the polymer film can be preferably 7 to 50 μm, especially 10 to 35 μm.

Thermoplastic polymers, preferably polyolefins, can be used as polymer film. In a special embodiment of the invention, bi-axially oriented polyolefin films can be used, especially polypropylene films.

The commercially available bi-axial fully drawn polyolefin films are produced in a co-extrusion process and are generally comprised of a porous core layer and at least one non-porous surface layer.

The polymer film in accordance with the invention is used on at least one side of the support material. In a special embodiment of the invention, the polymer foil is laminated onto the backside or the front side of the support material. However, it can also be applied to the backside as well as to the front side of the support material. The front side of the support material is the side that faces the printable self-adhesive film. The backside is the opposite side of the support material.

The support material can be an non-coated raw paper, a coated raw paper, or a raw paper that is coated with a thermoplastic resin. The surface weight of the raw paper can be 20 to 250 g/m² per square meter, preferably 50 to 200 g/m². Suitable cellulose materials for the production of the raw paper are all cellulose fibers and synthetic fibers. Softwood cellulose and hardwood cellulose, comminuted with alkaline or acid, can be used. All known adhesive agents and additives used in the paper industry can be used or the preparation of the raw paper.

The thermoplastic resin that coats the raw paper is preferably a polymer from the polyolefin group such as polyethylene, polypropylene, polymethylpentene, polybutylene and copolymers of two or more olefins or mixtures thereof. Especially preferred are all types of polyethylene such as high-density polyethylene (HDPE), low-density polyethylene (LDPE), linear low-density polyethylene (LLDPE) and mixtures thereof. Other suitable thermoplastic resins are polyester, polycarbonate, polyurethane or polyamide. The thermoplastic resin can be applied with extrusion coating. The application weight of the thermoplastic resin applied to the raw paper can be 5 to 50 g/m², preferably 10 to 35 g/m², but especially preferred 15 to 25 g/m².

In a special embodiment of the invention, a polyethylene mixture is applied to the front side of the raw paper. Said polyethylene mixture contains 10 to 90 percent-by-weight, especially 30 to 70 percent-by-weight, of a high-density (HDPE) polyethylene. The application weight of the coating can be 5 to 35 g/m², especially 15 to 25 g/m².

The release liner, which is obtained through the subsequent application of silicon, for example an aqueous silicon emulsion commonly used for this purpose (silicon application of<1.5 g/m²) to the coated support material in accordance with the invention, is coated with an adhesive and applied to the printable thermoplastic film, or brought into congruence with said film, which yields a multi-layer graphic film in accordance with the invention.

The printable thermoplastic film applied to the release liner in accordance with the invention can be a polyester film or a polyvinyl chloride film (vinyl film). It is glued to the release liner. All conventional aqueous and solvent-containing adhesive agents can be used as adhesives.

After the printing of the graphic film, the release liner is pulled of at the location between the silicon layer and the adhesive layer, and the film, which is now self-adhesive, can then be glued to the intended surface, i.e., the permanent support.

The following examples explain the invention in greater detail.

### Preparation of the Graphic Films

### EXAMPLE 1a

The front side of a neutrally sized raw paper of 31 percent-by-weight hardwood sulfate cellulose and 69 percent-by-weight softwood sulfate cellulose with a surface weight of 120 g/m² was coated with a polyethylene mixture of 50 percent-by-weight LDPE (d=0.915 g/m³) and 50 percent-by-weight HDPE (d=0.959 g/m³, by extrusion. The application weight was 24 g/m².

A bi-axially oriented polypropylene film with a thickness of 30 μm was laminated onto the backside of the raw paper. In the lamination, a low-density polyethylene (LDPE, density 0.915 g/m³) was extruded in a quantity of 12 g/m² between raw paper and polypropylene film.

The polypropylene film is comprised of a micro-porous polypropylene core with a thickness of approximately 18 μm, which has a thin, largely pore-free polypropylene surface layer with a thickness of approximately 6 μm on both sides. The MD/TD ration of the elasticity module in longitudinal- and transverse direction is 0.85. In the next step, the laminated paper was coated with silicon in a quantity of 0.5 g/m² and glued with a vinyl film.

### EXAMPLE 1b

The method is the same as in Example 1a, with the difference that a raw paper with a surface weight of approximately 90 g/m² was used.

### EXAMPLE 2a

The coating was performed in the same ways as in Example 1a, with the difference that a polypropylene film with a thickness of 15 μm and an MD/TD-ratio of 0.55 was used.

### EXAMPLE 2b

The method was the same as in Example 2a, with the difference that a raw paper with a surface weight of 90 g/m² was used.

### EXAMPLE 3a

The raw paper from Example 1a was laminated on both sides with the same polypropylene film (30 im), whereby a polyethylene layer of a low-density polyethylene (LDPE, density 0.915 g/m²) was applied between each raw paper and polypropylene film in a quantity of 12 grams per square meter. Then the process continued as described in Example 1.

### EXAMPLE 3b

The coating was performed as in Example 3a, with the difference that a raw paper with a surface weight of approximately 90 g/m² was used.

### EXAMPLE 4a

The coating was performed according to Example 3a with the difference that a polypropylene film with a thickness of 15 μm and an MD/TD-ratio of 0.55 was used.

### EXAMPLE 4b

The coating was performed as in Example 4a, with the difference that a raw paper with a surface weight of 90 g/m² was used.

### COMPARATIVE EXAMPLE V1

The front side of a raw paper with a surface weight of 120 g/m² was coated by extrusion with a low-density polyethylene (LDPE, 0.915 g/m³) in a quantity of 24 g/m². The backside of the raw paper was coated with a high-density polyethylene (HDPE, 0.940 g/m³) in a quantity of 12 grams per square meter. The silicon treatment and the application of the vinyl film were performed according to Example 1.

### COMPARATIVE EXAMPLE V2

The method used was the same as in V1, but with a raw paper of 90 g/m².

### Testing of the Graphic Films

The dimensional stability of the graphic film in accordance with the invention was tested at various temperatures and air humidity. For this purpose, the curl behavior and a so-called curling index (WI) were determined. The measuring of the curl was performed on a length of graphic film rolled out on a level substrate.

WT=Number of curls per 2 meters×mean curl amplitude [mm]×mean curl depth in transverse direction [cm]

Graphic films with a curling index<200 [10⁻⁵ m] have a good dimensional stability in various humidity conditions.

The curl measurements were taken at the corners of the material to be tested (30 cm×30 cm) by means of an alignment gauge. The height between the support and the high corner were measured, and a mean value in mm was determined from the measuring value. Positive values mean that the corners curl toward the front side, negative values mean a curl to the back.

The determined values are compiled in Table 1.

TABLE 1

| | Curl | Curl | Curl | | |
|---|---|---|---|---|---|
| | 10° C./20% | 23° C./50% | 32° C./80% | | |
| | relative | relative | relative | | |
| | humidity | humidity | humidity | ΔCurl | Curl |
| Example | [mm] | [mm] | [mm] | [mm] | Index |
| 1q | −0.6 | 0.1 | 1.1 | 1.7 | 63 |
| 1b | −0.8 | 0.2 | 1.4 | 2.2 | 73 |
| 2a | −0.7 | 0.0 | 1.4 | 2.1 | 88 |
| 2b | −0.9 | −0.1 | 1.7 | 2.6 | 95 |
| 3a | −0.5 | 0.1 | 0.9 | 1.4 | 59 |
| 3b | −0.8 | 0.1 | 1.3 | 2.1 | 65 |
| 4a | −0.6 | 0.0 | 1.2 | 1.8 | 55 |
| 4b | −0.8 | 0.2 | 1.3 | 2.1 | 72 |
| V1 | −3.0 | 0.1 | 4.2 | 7.2 | 1520 |
| V2 | −4.5 | 0.2 | 5.2 | 9.7 | 1980 |

Curl: Mean value of four corners, measured from the support (+: VS, −: RS);

Delta (Δ) Curl: Curl 10°/20% relative humidity (rF)—Curl 32°/80% relative humidity;

Curl index: number of curls per 2 meters×mean curl amplitude [mm]×mean curl depth in CD [cm];

Increasing temperature: delta positive;

Increasing humidity: delta negative.

The table shows that the graphic films in accordance with the invention have a low curl index and improved curl behavior compared to conventional graphic films.

We claim:

1. Multi-layer graphic film comprising a printable self-adhesive thermoplastic film and a release liner, wherein the release liner contains a support material coated on at least one side with a polymer film, which has a ratio of the elasticity modules in longitudinal and transverse direction (MD/TD) of<1, measured according to DIN 53455.

2. Multi-layer graphic film according to claim 1, wherein the ratio MD/TD is in a range of 0.3 to 0.8.

3. Multi-layer graphic film according to claim 1, wherein the polymer film is a polyolefin film.

4. Multi-layer graphic film according to claim 1, wherein the polyolefin film is a bi-axially oriented polypropylene film.

5. Multi-layer graphic film according to claim 1, wherein the polymer film is arranged on the backside of the support material.

6. Multi-layer graphic film according to claim 1, wherein the polymer film is arranged on the backside and on the front side of the support material.

7. Multi-layer graphic film according to claim 1, wherein the thickness of the polymer film is 7 to 50 μm.

8. Multi-layer graphic film according to claim 1, wherein the support material is a raw paper coated with polyolefin on at least one side.

9. Multi-layer graphic film according to claim 8, wherein the support material is coated with a low-density polyolefin (LDPE).

10. Multi-layer graphic according to claim 8, wherein the raw paper is coated on the front side with a polyethylene mixture containing 10 to 90 percent-by-weight HDPE.

11. Multi-layer graphic film according to claim 10, wherein the application weight of the high-density polyethylene is 5 to 35 g/m².

12. Multi-layer graphic film according to claim 1, wherein the printable thermoplastic film is a polyester film or a vinyl film.
